(19) United States
(12) Patent Application Publication
(10) Pub. No.: US 2004/0210485 A1
(43) Pub. Date: Oct. 21, 2004

(54) Quoting strategy analysis system and method

(76) Inventors: Sheng Chi Luo, Tu-Chen (TW); Qiong Shuai Chen, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/827,967

(22) Filed: Apr. 19, 2004

(30) Foreign Application Priority Data
Apr. 18, 2003 (TW) 92109038

(51) Int. Cl. G06F 17/60

(52) U.S. Cl. 705/15

(57) ABSTRACT

A quoting strategy analysis system includes a database server (1), an application server (2), and a plurality of client computers (4) located in various different places. The system is connected with an information management system (5) and a financial management system (6). The quoting strategy analysis system is for collecting product prices information, determining whether product prices are abnormal, calculating product costs, analyzing product prices, and generating price analysis reports. The client computers are for searching, editing and deleting information on product prices. A related quoting strategy analysis method is also disclosed.

### FIELD OF THE INVENTION

This invention is related to computer-enabled systems and methods for commercial quoting, and especially to systems and methods for quote analysis by comparing quotations of buyers with historical transaction prices.

### BACKGROUND OF THE INVENTION

Traditional commercial product acquisition may be simplified down to three basic steps: (a) buyers quote respective prices that they are prepared to pay for a same product; (b) suppliers analyze the prices; and (c) the suppliers negotiate with the buyers to determine respective prices for the product. In line with the development of Internet technology, quoting and price analysis is frequently performed through the World Wide Web. Chinese patent application CN1350256A published on May 22, 2002, and entitled Estimate Mediating Method And Device, discloses an estimating mediating method. The method comprises: receiving a condition of an estimate request made by a buyer as estimate request information; evaluating sellers on the basis of data stored in advance; determining an order of priority of the sellers on the basis of the evaluation; determining a plurality of sellers to be selected as the sellers who can make a response to the estimate request, in accordance with the order of priority; allowing the selected sellers to read the estimate request information; receiving a response to the estimate request from each selected seller, each such response comprising estimate response information; indicating sellers who have sent responses to the estimate request to the buyer, in accordance with the order of priority; and allowing the buyer to read all the estimate response information.

However, this patent application does not provide any function of comparing quotations of buyers with historical transaction prices.

### SUMMARY OF THE INVENTION

A primary object of the present invention is to provide a quoting strategy analysis system and method, which determines whether quotations of buyers are abnormal by comparing such quotations with corresponding price ranges, which generates information on abnormal quotations, and which sends such information to the buyers.

Another object of the present invention is to provide a quoting strategy analysis system and method which automatically calculates product costs.

To achieve the above objects, in one aspect of the present invention, a quoting strategy analysis system comprises: a database server for storing information on product prices; an application server for receiving information on quotations of buyers from an information management system, and for receiving historical product prices and product price deviations from a financial management system; and a plurality of client computers for searching, editing and deleting information on product prices. The application server comprises a price analysis module for generating a price range for each product based on the historical records of product prices and product price deviations and determining whether quotations of buyers are within corresponding price ranges, and an abnormal quotation-processing module for generating information on abnormal quotations and sending the information on abnormal quotations to corresponding buyers when quotations of the buyers are not within the respective price ranges.

In another aspect of the present invention, a quoting strategy analysis method comprises the steps of: receiving information on quotations of buyers from an information management system, and receiving historical records of product prices and product price deviations from a financial management system; generating a price range based on the historical records of product prices and the product price deviations; determining whether a quotation of a buyer is within a corresponding price range by comparing the quotation of the buyer with the price range; and generating information on an abnormal quotation, and sending the information on the abnormal quotation to the buyer, if the quotation of the buyer is not within the price range.

Other objects, advantages and novel features of the present invention will be drawn from the following detailed description of preferred embodiments of the present invention with the attached drawings, in which:

### BRIEF DESCRIPTION OF THE DRAWINGS

FIG. 1 shows system architecture of a quoting strategy analysis system in accordance with the preferred embodiment of the present invention;

FIG. 2 is a data source flow chart on price information of the system of FIG. 1;

FIG. 3 is a schematic diagram of function modules of an application server of the system of FIG. 1;

FIG. 4 illustrates an exemplary price analysis report in accordance with the present invention; and

FIG. 5 is a flow chart of preferred operation of the quoting strategy analysis system.

### DETAILED DESCRIPTION OF THE PREFERRED EMBODIMENT

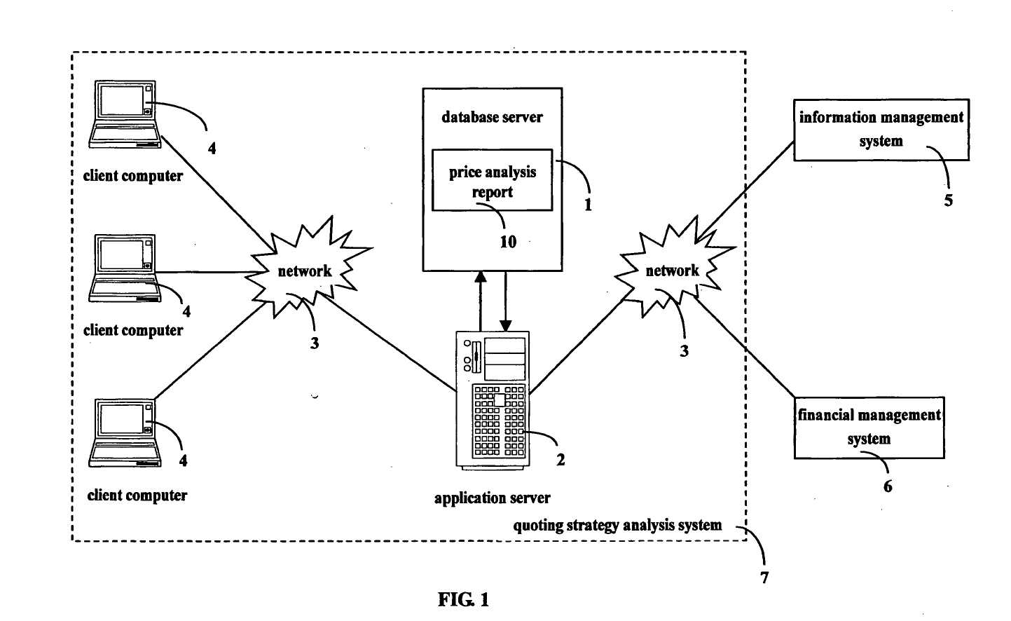

FIG. 1 shows system architecture of a quoting strategy analysis system 7 in accordance with the preferred embodiment of the present invention. The quoting strategy analysis system 7 comprises a database server 1, an application server 2, a network 3, and a plurality of client computers 4. The network 3 is a conventional electronic communication network, which may for example be an intranet, the Internet or another suitable network. The quoting strategy analysis system 7 is interconnected with an information management system 5 and a financial management system 6 through the network 3. The information management system 5 is used for receiving information from buyers, said information including information on quoting and information on demand for products. The financial management system 6 provides information on historical records of product prices and costs.

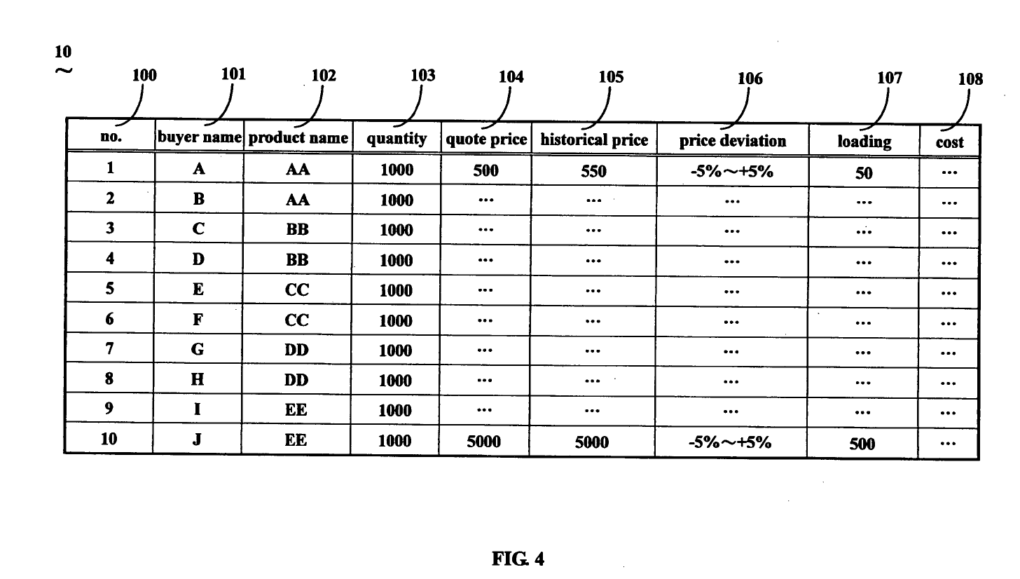

The database server 1 is used for storing information on product prices. The application server 2 is used for receiving information on quotations and information on historical records of product prices and costs, and generating price analysis reports 10. This is described in more detail below with reference to FIG. 4. The application server 2 generates a price range of each product, and determines whether corresponding quotations of buyers are abnormal compared with the corresponding price ranges. A quotation is defined as being abnormal if it is not within the corresponding price range. The client computers 4 are located in various different places of an organization employing the quoting strategy analysis system 7. The client computers 4 are used for searching, editing, and deleting the price analysis reports 10.

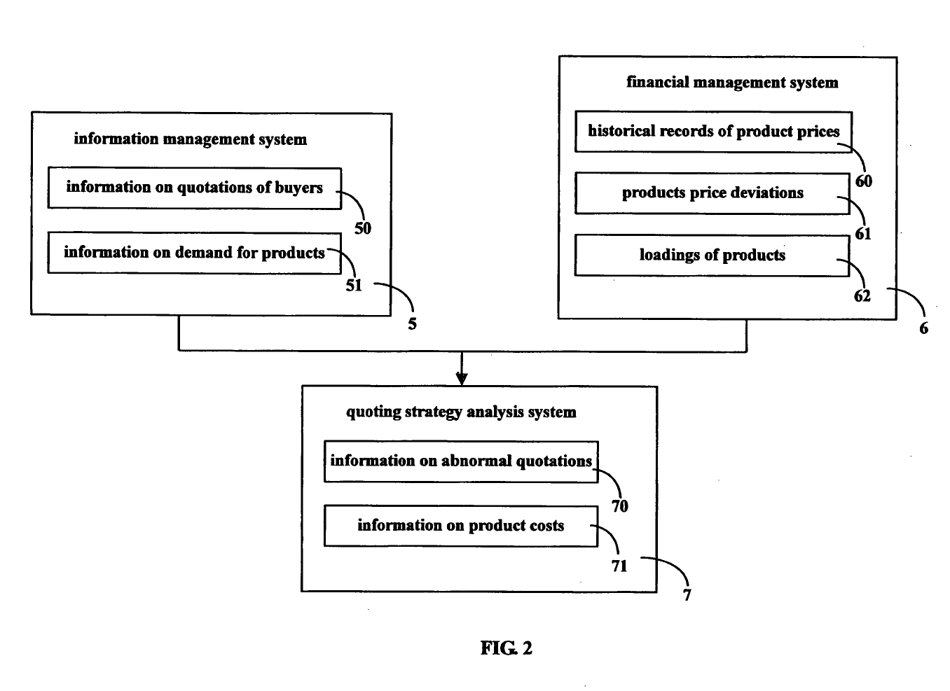

FIG. 2 is a data source flow chart on price information of the quoting strategy analysis system 7. The quoting strategy analysis system 7 receives information on product prices from the information management system 5 and the financial management system 6, determines whether corresponding quotations of buyers are abnormal, and calculates product costs. The information management system 5 provides information on quotations of buyers 50, and information on demand for products 51. The information on quotations of buyers 50 includes names of buyers, names of products, and details of quotations of the buyers. The information on demand for products 51 includes names of buyers, names of products, and quantities of products in demand. The financial management system 6 provides historical records of product prices 60, product price deviations 61, and information on loadings of products 62. The quoting strategy analysis system 7 generates information on abnormal quotations 70 and information on product costs 71.

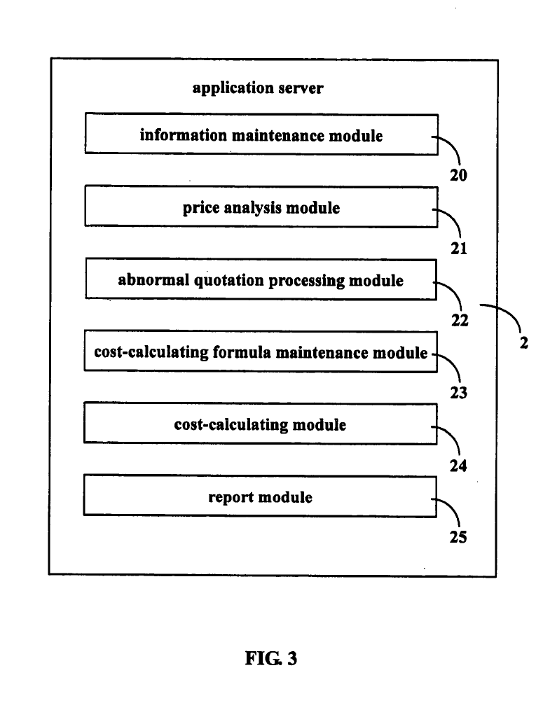

FIG. 3 is a schematic diagram of function modules of the application server 2. The application server 2 comprises an information maintenance module 20, a price analysis module 21, an abnormal quotation-processing module 22, a cost-calculating formula maintenance module 23, a cost-calculating module 24, and a reporting module 25. The information maintenance module 20 is used for searching, editing, and deleting price analysis reports 10. The price analysis module 21 is used for generating a price range for each product based on the historical records of product prices 60 and product price deviations 61, and determining whether a quotation of a buyer is within the corresponding price range. The abnormal quotation-processing module 22 is provided for generating information on abnormal quotations 70, and sending the information on abnormal quotations 70 to corresponding buyers when quotation of the buyers are not within the respective price ranges. The cost-calculating formula maintenance module 23 is used for modifying cost calculating formulas that are stored in the database server 1. The cost-calculating module 24 is provided for calculating product costs according to the cost calculating formulas and respective loadings of the products. A loading is an amount added to the cost of a product because of the expense of providing additional service or of additional production. The reporting module 25 is provided for generating the price analysis reports 10.

FIG. 4 illustrates an exemplary price analysis report 10 in accordance with the present invention. The price analysis report 10 records information on product prices, and includes the following columns: no. 100, buyer name 101, product name 102, quantity 103, quote price 104, historical price 105, price deviation 106, loading 107, and cost 108. The no. 100 is the sequence number of the historical record. The buyer name 101 is the name of the buyer that wants to buy the product and that quotes a price. The product name 102 is name of the product wanted by the buyer. The quantity 103 is the quantity of the product that the buyer wants to buy. The quote price 104 is quoted by the buyer, and is retrieved from the information management module 5. The historical price 105 is the historical transactional price of a same product, and is retrieved from the financial management system 6. The price deviation 106 is the extent to which the product price is allowed to vary, and is retrieved from the financial management system 6. The loading 107 is the expense of providing additional service or of additional production, and is retrieved from the financial management system 6. The cost 108 is the product cost calculated by the cost-calculating module 24.

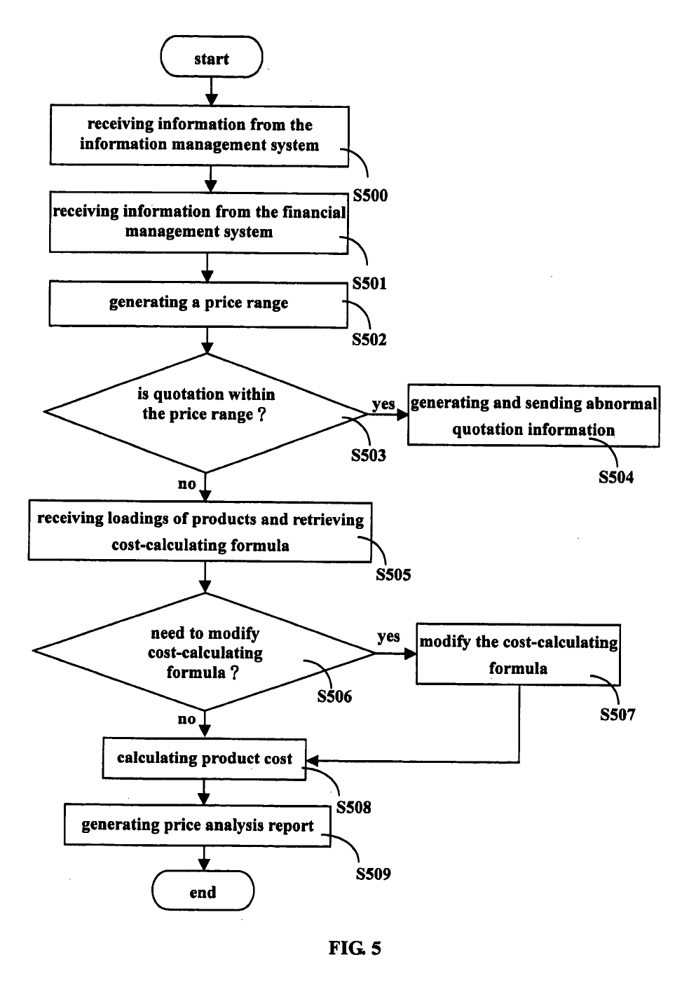

FIG. 5 is a flow chart of preferred operation of the quoting strategy analysis system 7. Firstly, in step S500, the quoting strategy analysis system 7 receives information on demand for products 51 and information on quotations of buyers 50 from the information management system 5. In step S501, the quoting strategy analysis system 7 receives historical records of product prices 60 and product price deviations 61 from the financial management system 6. In step S502, the price analysis module 21 generates a price range for a particular product based on the historical records of product prices 60 and product price deviations 61. In step S503, the price analysis module 21 determines whether a corresponding quotation of a buyer is within the price range, by comparing the quotation of the buyer and the price range. If the quotation of the buyer is not within the price range, in step S504, the abnormal quotation-processing module 22 generates abnormal quotation information and sends the abnormal quotation information to the buyer. If the quotation of the buyer is within the price range, in step S505, the quoting strategy analysis system 7 receives information on loadings of products 62 from the financial management system 6, and retrieves one or more applicable cost-calculating formulas stored in the database server 1. In step S506, users determine whether any cost-calculating formula needs to be modified to meet the actual conditions of the proposed transaction, including product features and negotiated terms. If any cost-calculating formula does not need to be modified, the procedure goes directly to step S508 described below. If a cost-calculating formula needs to be modified, in step S507, the users modify the cost-calculating formula through the cost-calculating formula maintenance module 23, whereupon the procedure goes to step S508. In step S508, the cost-calculating module 24 calculates the product costs and stores the product costs in the database server 1. Finally, in step S509, the report module 25 generates price analysis reports 10, which are stored in the database server 1. The price analysis reports 10 is then available for searching, editing, and deleting by the users through any of the client computers 4.

The embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description but rather by the spirit and scope of the claims that follow, and their equivalents.

What is claimed is:

1. A quoting strategy analysis system, comprising:
a database server for storing information on product prices;
an application server for receiving information on quotations of buyers from an information management system and receiving historical product prices and product price deviations from a financial management system, the application server comprising:
a price analysis module for generating a price range for each product based on the historical records of product prices and product price deviations, and determining whether quotations of buyers are within corresponding price ranges; and
an abnormal quotation-processing module for generating information on abnormal quotations, and sending the information on abnormal quotations to corresponding buyers when quotations of the buyers are not within the respective price ranges; and
a plurality of client computers for searching, editing and deleting information on product prices.

2. The quoting strategy analysis system as claimed in claim 1, wherein the application server further comprises a cost-calculating module for calculating product costs.

3. The quoting strategy analysis system as claimed in claim 2, wherein the application server further comprises a cost-calculating formula maintenance module for modifying cost-calculating formulas.

4. The quoting strategy analysis system as claimed in claim 3, wherein the application server further comprises a report module for generating price analysis reports.

5. The quoting strategy analysis system as claimed in claim 2, wherein the application server further comprises a report module for generating price analysis reports.

6. A quoting strategy analysis method, comprising the steps of:
receiving information on quotations of buyers from an information management system and historical records of product prices and product price deviations from a financial management system;
generating a price range based on the historical records of product prices and the product price deviations;
determining whether a quotation of a buyer is within a corresponding price range by comparing the quotation of the buyer with the price range; and
generating information on an abnormal quotation, and sending the information on the abnormal quotation to the buyer if the quotation of the buyer is not within the price range.

7. The quoting strategy analysis method as claimed in claim 6, further comprising the following steps:
receiving loadings of products;
retrieving one or more cost-calculating formulas from a database server; and
calculating product costs and storing the product costs in the database server.

8. The quoting strategy analysis method as claimed in claim 7, further comprising the following steps after retrieving one or more cost-calculating formulas from a database server:
determining whether any cost-calculating formula needs to be modified; and
modifying a cost-calculating formula, if the cost-calculating formula needs to be modified.

9. The quoting strategy analysis method as claimed in claim 8, further comprising steps of generating price analysis reports and storing the price analysis reports in a database server.

10. The quoting strategy analysis method as claimed in claim 7, further comprising the step of generating price analysis reports, and storing the price analysis reports in the database server.

11. The quoting strategy analysis method as claimed in claim 6, further comprising a step of generating price analysis reports and storing the price analysis reports in the database server.
